(19) United States
(12) Patent Application Publication
(10) Pub. No.: US 2007/0104452 A1
(43) Pub. Date: May 10, 2007

(54) One-click video recording system and method

(75) Inventors: Ming-Chang Wang, Taipei (TW); Wen-Hsiung Chang, Taipei (TW); Chia-Chang Chuang, Taipei (TW); Chad-Cheng Linwu, Taipei (TW)

Correspondence Address: BACON & THOMAS, PLLC, 625 SLATERS LANE, FOURTH FLOOR, ALEXANDRIA, VA, 22314, US

(73) Assignee: CLEVO CO., TAIPEI (TW)

(21) Appl. No.: 11/584,668

(22) Filed: Oct. 23, 2006

(30) Foreign Application Priority Data
Oct. 21, 2005 (TW) 94136942

(51) Int. Cl. H04N 5/91

(52) U.S. Cl. 386/46

(57) ABSTRACT

A computer apparatus and system having the functionality of one-click video recording enables and stops the video camera module via a controller requesting the system chip. By method of matching to loopup the mapping table embedded in input/output (I/O) system, the functional hotkey is pressing to approach recording image and audio via the execution of the video application program.

### FIELD OF THE INVENTION

The invention provides a system and its operational method to record image and voice simultaneously by clicking a functional hotkey which is embedded in a computer.

### BACKGROUND OF THE INVENTION

The video recording functionality on a common computer apparatus requires the associated video recording apparatus, such as a webcam or an external video camera, and the associated video recording application program installed in the computer system. To start video recording, the associated video recording application needs to be launched, and the video recording apparatus needs to be triggered by the software drivers via specific interface. During the recording process, the video image will be saved into the media devices such as hard disc or compact disc.

The related art, such as “Computer-Implemented Image Acquisition System” illustrated in U.S. Pat. No. 5,138,459, revealed its ability to capture the video image via the video image capturing apparatus and save the data of the video image in the memory of the computer system. As shown in FIG. 1, the video image capturing system 20 comprised of plurality of video devices, such as scanner 201, video camera 202, and camera 203, which connected to a computer 22. The computer 22 is a common used computer system comprising Central Processing Unit (CPU) 21, system memory 23, data memory device 25 for the store of video/audio contents, display unit 27, and communication interface 29 for the interchange of data of peripheral devices. After loading operating system (OS) 26 stored in compact disc, hard disc or other non-volatile program memory devices 28, the management system 282 executed by OS 26 will scan, capture, save and send video image via graphical user interface 281.

In contrast to the complicated steps to record video images by using the computer device as illustrated in the related art, such as driving the hard drives, executing the software and managing the files, current invention provides an apparatus of a computer device with one-click recording functionality for easier and quicker video recording operation.

### SUMMARY OF THE INVENTION

One-click video recording system and method is featuring the computer of a hotkey to initiate the functionality of video recording automatically. The hotkey can be external functional keys or the combination of the keys on the traditional keyboard, or the functional keys as defined in related art (F1, F2 . . . F12). The users can operates the hotkey to promptly complete the steps for video recording such as signals transmitting/receiving, video recording, sound recording and media files management by one-clicking.

The video recording system with one-click hotkey comprises a video capturing apparatus, a toggle apparatus, CPU, input/output (I/O) system, storing media and the application program. Herein the video capturing apparatuss coupling to the system chipset of the computer system, such as the SouthBridge chipset, is utilizing to capture dynamic video image. The toggle apparatus might configuring on the computer apparatus is featuring of startup or shutdown of the recording functionality when press/release command is received. The I/O System coupling to the system chip includes a table. The storing media configuring in the computer system is utilizing to store the media contents captured by said video recording apparatus. And the application program loaded in the computer system is executed to record the captured media contents.

To realize the one-click video recording functionality initialed by the functional key, the video recording functionality signal produced by one-clicking the above toggle apparatus will request the computer system chipset to startup the video recording module via controller, such as the CPU, and to launched the video recording application by lookup table method via BIOS.

Another embodiment of the one-click video recording functionality in accordance to the current invention is when a functional key is toggled, the toggle signal produced by the functional key will be sent to the CPU, the system chipset and the I/O System. By the method of lookup the mapping table, the video recording apparatus and the video recording application will be driven and launched respectively to start video recording, and to store the video recording contents into the storing media simultaneously.

### BRIEF DESCRIPTION OF THE DRAWINGS

FIG. 1 illustrates an embodiment of the related prior art.

FIG. 2 and FIG. 3A illustrates the embodiment in accordance with the present invention.

FIG. 3B illustrates the embodiment in accordance with the present invention with dual-monitor computer apparatus.

FIG. 4 illustrates the computer system architecture of the embodiment in accordance with the present invention.

FIG. 5 illustrates the video recording system architecture of the embodiment in accordance with the present invention.

FIG. 6 and FIG. 7 is the operation flow chart of the recording method of one-click video recording system in accordance with the present invention.

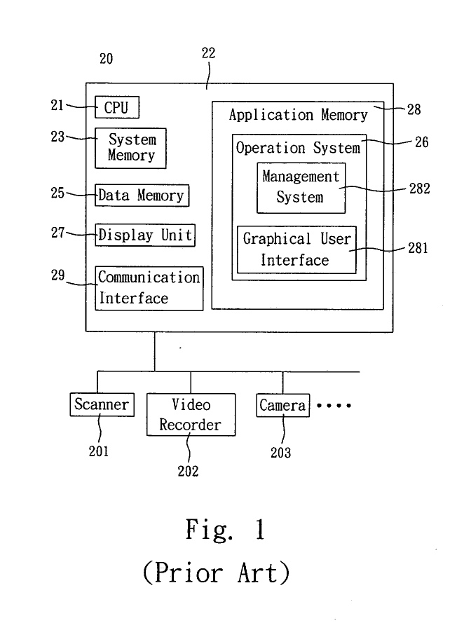

### DESCRIPTION OF THE PREFERRED EMBODIMENTS

In order to overcome the complexity of the commands or execution operations to trigger the video recording functionality in the related art, current invention provides the apparatus and the operational method of a video recording system with one-click functional hotkey for video recording. The one-click functional key triggers the video recording functionality to drive the video camera module by computer system chip, and to launch the video camera application via BIOS by method of lookup to a mapping table.

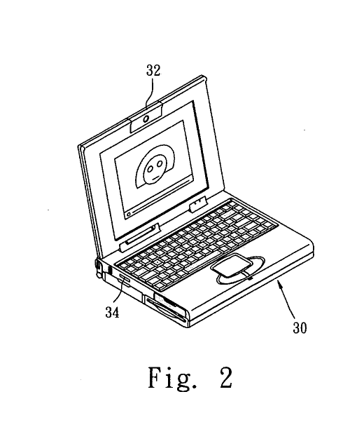

FIG. 2 illustrates one of the preferred embodiments in accordance with present invention, which equipped with functional key 34 on a computer, herein a notebook computer 30 equips with a video recording apparatus 32, for video recording functionality. The execution of video recording and automated data storing will start once the functional key 34 is pressed by the user. Because the functional key 34 is configured by the way of mechanism to control the peripheral apparatus via I/O system of computer system and to trigger an application program for video recording, this embodiment utilizes a video recording apparatus 32 in build-in mode.

The above functional key 32 of the embodiment in accordance with the present invention can be a computer functional key as utilized in related art. The functional key 32 can also be configured as the toggle switch produced by hardware manufacturer to startup or shutdown the functionality of video recording via the electrification connection of the functional key 32 and the computer apparatus. Also, the functional key 32 can be the combination of plurality keys from the keyboard, such as combining the keys of “Ctrl” or “Shift” with other key, or combining “Fn” key with one of the original function key (F1, F2 . . . F12), or just refined any key in the keyboard to trigger the video recording functionality.

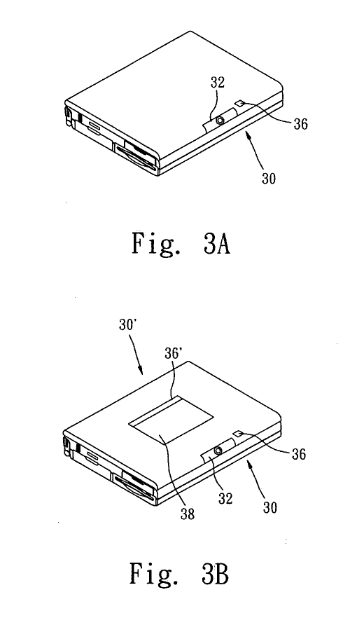

FIG. 3A illustrates one of the preferred embodiment in accordance with present invention, which enables the functionality of video recording and storing operation by built-in or external video recording apparatus via the functional key 36, even when the lid of the notebook computer 30 is closed. In this embodiment, the associated video recording hardware, such as the CPU, storing media, I/O system, and controller of video recording apparatus, will be activated by one-clicking the functional key 36 even when the computer system has been shut down. Furthermore, the functionality of video recording can operates in sleep mode, standby mode and power saver mode.

FIG. 3B illustrates the embodiment in accordance with current invention with dual-monitor computer. Similarly, the dual-monitor computer activates the secondary monitor 38 and enables the functionality of video recording and storing operation by the built-in or external video recording apparatus via the startup key 36′, which can be attached to the secondary monitor 38 or provided in the secondary monitor 38, even when the lid of said notebook 30 is being closed. The secondary monitor 38 can be used to monitor the recording status. By utilization of the startup key 36′ attached on the secondary monitor 38, the associated video recording hardware in the system, such as functional key 36 or other hardware apparatus illustrated in FIG. 3A, can be activated.

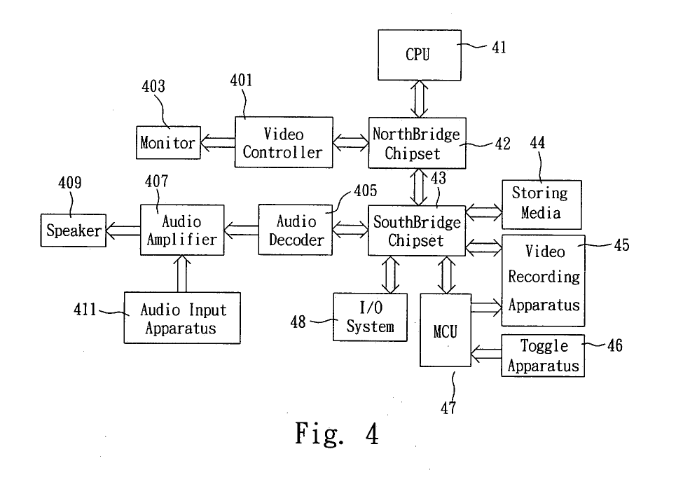

FIG. 4 illustrates the computer system architecture of one of the embodiment in accordance with present invention. The computer system comprises as below:

1. CPU 41 and the associated NorthBridge chipset 42 and SouthBridge chipset 43, those are configured to connect other peripheral apparatus for normally execution of the computer system.

2. Storing apparatus 44, such as compact disc, hard disc and other storing media, coupling to SouthBridge chipset 43, and utilizing to store the contents captured from the video recording apparatus.

3. Video recording apparatus 45, coupling to SouthBridge chipset 43, herein the process of the video signals such as compress, decompress, encode, decode and file saving/loading is executed cooperatively with CPU 41.

4. Microprocessor 47, coupling to the SouthBridge chipset 43, utilizing to read the operation codes produced by the toggle apparatus 46 or the key codes produced by the functional button of current invention, and sending the operation/key codes to the I/O system 48 via SouthBridge chipset. The video recording apparatus 45 and associated application is activated by a enabling signal after matching the lookup of the mapping table.

5. Toggle apparatus 46, configured in the computer apparatus, utilizing to startup or shutdown the one-click video recording functionality by reading the key-pressed commands.

6. Video peripherals, such as video controller 401, coupling to the NorthBridge chipset 42, utilizing to display the operating system information on the monitor 403.

7. Audio peripherals, such as audio decoder 405 coupling to the SouthBridge chipset 43, utilizing to decode and decompress the audio signals. The audio signals will be output via speaker 409 after being amplified by the audio amplifier 407. Besides, audio input apparatus 411, such as microphone, serves as the input of external audio source. The audio signals will then be decoded and decompressed by the audio decoder 405, being amplified by audio amplifier 407, and being output via speaker 409.

The video recording system with one-click recording functionality as illustrated by present invention at least includes storing media 44 coupling to the SouthBridge chipset, video recording apparatus 45, CPU 47, I/O system 48 and toggle apparatus 46, microcontroller 47 as the embedded controller (EC) or keyboard controller (KBC) to receive and identify the signals produced by the toggle apparatus 46, video recording apparatus 45, which can be the built-in or external web cam, being connected to the computer system via USB, IEEE1394 or other wireless protocols. The toggle apparatus 46 in the present invention is shown in FIG. 2, FIG. 3A and FIG. 3B for the properly embodiment.

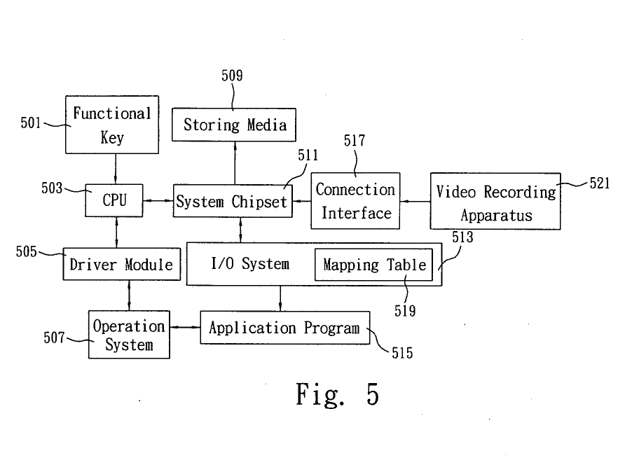

The video recording system architecture of the embodiment in accordance with the present invention is illustrated in FIG. 5. Functional key 501 can be the toggle switch configured by hardware manufacturer; or can be the combination of plurality of keys on the keyboard, such as the combination of the keys of “Ctrl” or “Shift” with other key, or the combination of “Fn” with one of the functional key (F1, F2 . . . F12), or re-defined key of the original keyboard.

The controller signals produced by pressing the functional key 501, such as key codes of the enabling signal and the stopping signal, will be sent to CPU 503. After that, CPU 503 send the signals to the system chipset 511, and enables the operation system 507 to execute the functionalities produced by the functional key 501 and other peripheral hardware via driver module 505. For instance, when the functional key 501 is pressed, the application program 515 associated to the functional key 501 will be executed via the operation system 507.

In present invention, the video signals recorded by the application program installed in the operating system can be saved in the storing media 509 via the system chipset 511. A mapping table 519 is built in the I/O system 513, which is configured to the system chipset 511. The mapping table 519 stores the matching relations between the functional key 501 and the associated hardware functionalities. When a functional button 501 is pressed, after matching to lookup the mapping table, video recording apparatus 521 will be activated by system chipset 511 via connection interface 517. The aboved mapping table 519 can also match the functional key 501 with the associated application program 515. When the functional key 501 with video recording function is pressed, the video recording application program 515 will be executed via the operation system 507.

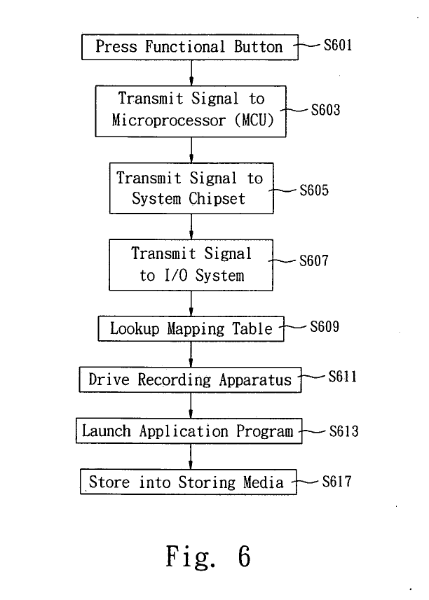

FIG. 6 illustrates the operation flow chart of the recording method of one-click video recording system in accordance with the present invention. To enable the functional button with video recording functionality of present invention to be applied in any situations, the functional button is designed to be operated in the computer system under any power modes. In one of the embodiment, even if the computer system is in shutdown mode, the signals produced by the video recording functional button can be received by the microprocessor, which is in standby mode. When the computer system is in startup mode, shutdown mode or other power saver mode, if the user pressed the special functional button, the pre-defined functional key on the original keyboard, or “Fn”, “Ctrl key”, “Shift”, “Alt” with other key, or the startup button attached on the secondary monitor (Step S601), the enabling signal produced by the functional button will transmit to the microprocessor (Step S603), and system chipset (Step S605) via the configuration between the keyboard controller, system chipset and I/O system. After that, system chipset transmits the enabling signal to the I/O system. Next, the I/O system matches the contents of the mapping table of the system chipset (Step S609). By utilizeing to lookup the mapping table method, the video recording apparatus, or the accompanied associated audio capturing apparatus will be driven by the system chipset via specific interface (Step S611). Meanwhile, by method of utilizing to lookup the mapping table, the associated video recording application program installed in the operating system will be launched by the signals transmitted from the microprocessor via operating system to the I/O system of system chipset. The application program can launch the audio or/and video capturing apparatus to capture audio/video (Step S613), and also store the video/audio contents into the storing media (Step S617).

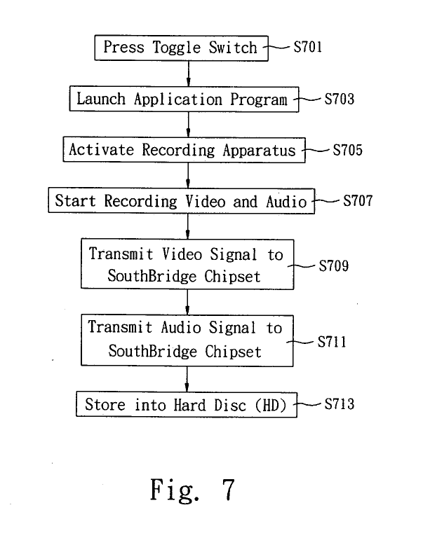

FIG. 7 is the operation flow chart of another embodiment in accordance with the present invention. When the toggle switch is pressed by the user in power on mode of the computer (Step S701), the video recording application program will be launched by the microprocessor via operating system (Step S703), and the video recording apparatus will be activated via system chipset (Step S705) to start recording video and audio (Step S707). Next, the video signals captured by the video recording apparatus will be transmitted to the SouthBridge chipset of the main system via connection interface (Step S709), and the audio signals captured by the audio source input apparatus will be transmitted to the SouthBridge chipset of the main system via audio decoder (Step S711). As the final step of the one-click video recording operation, the video/audio signal will be processed and saved into the hard disc via CPU and NorthBridge chipset (S713).

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. An one-click video recording computer, having a microprocessor coupling to a system chipset to execute an operating system, comprising:
a video recording apparatus, coupling to said system chipset;
a toggle apparatus, being configured on said computer and coupling to said microprocessor to control said video recording apparatus in executing said video recording operation;

2. The computer as set forth in claim 1, wherein a storing media coupling to said system chipset is used to store video information captured by said video recording apparatus.

3. The computer as set forth in claim 1, wherein an I/O system coupling to said system chipset is utilizing to control said video recording apparatus via a controlling signals received from said toggle apparatus.

4. The computer as set forth in claim 3, wherein said controlling signal is an enabling signal.

5. The computer as set forth in claim 3, wherein said controlling signal is a stopping signal.

6. The computer as set forth in claim 1, wherein said toggle apparatus is a toggle switch configured on said computer.

7. The computer as set forth in claim 1, wherein said toggle apparatus is a startup key provided by a secondary monitor configured on said computer.

8. An one-click video recording notebook computer, having a microprocessor coupling to a system chipset to execute an operating system, and initiating recording functionality by one-clicking a toggle apparatus, comprising:
a video recording apparatus, coupling to said system chipset to capture image and record audio simultaneously;
a toggle apparatus, configured on said notebook computer to receive toggling command, enabling or stopping said video recording apparatus;
an Input/Output (I/O) system, coupling to said system chipset, installing a mapping table;
storing media, configured in said notebook computer, utilizing to store the data captured by the said video recording apparatus;
herein said toggle apparatus transmits an enabling signal to said microprocessor to enable said video recording apparatus and said I/O system to execute an application program by lookup the mapping table.

9. The notebook computer as set forth in claim 8, wherein said microprocessor is a keyboard controller.

10. The notebook computer as set forth in claim 8, wherein said toggle apparatus is a toggle switch configured on said notebook computer.

11. The notebook computer as set forth in claim 8, wherein said toggle apparatus is redefined key configured on said notebook computer.

12. The notebook computer as set forth in claim 8, wherein said toggle apparatus is a startup key provided by a secondary monitor configured on said notebook computer.

13. The notebook computer as set forth in claim 8, wherein said application program enable an audio capturing apparatus to record audio.

14. An one-click recording method, by means of toggling a functional key configured on a computer apparatus to enable a video recording apparatus by lookup a mapping table installed in an I/O system, wherein the means comprise the steps of:
triggering said functional key;
transmitting an enabling signal to a microprocessor;
transmitting said enabling signal to a system chipset and said I/O system;
driving said video recording apparatus via said system chipset by lookup the mapping table;
executing an application program by the operating system (OS) associated with said system chipset in accordance with the mapping table; and
storing the recorded contents into storing media.

15. The one-click recording method as set forth in claim 14, wherein the step of transmitting an enabling signal to said system chipset and said I/O system is realized by the configuration between a keyboard controller, said system chipset and said I/O system.

16. The one-click recording method as set forth in claim 14, wherein the step of triggering said functional key is realized by pressing the toggle switch configured on the computer apparatus.

17. The one-click recording method as set forth in claim 14, wherein the step of triggering said functional key is realized by redefining keyboard of said computer apparatus.

18. The one-click recording method as set forth in claim 14, wherein the step of triggering said functional key is realized by a startup key provided by the secondary monitor configured on said computer apparatus.

19. The one-click recording method as set forth in claim 14, wherein the step of driving said video recording apparatus simultaneously drives an audio capturing apparatus.
